(19) United States
(12) Patent Application Publication
(10) Pub. No.: US 2008/0143094 A1
(43) Pub. Date: Jun. 19, 2008

(54) TWO-SIDED LABEL, LABEL STOCK, AND ASSOCIATED METHOD OF MAKING SAME

(75) Inventor: Robert Goetz, Garden Grove, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: FMC Technologies, Inc., Chicago, IL (US)

(21) Appl. No.: 11/612,200

(22) Filed: Dec. 18, 2006

(51) Int. Cl. B42D 15/00

(52) U.S. Cl. 283/67; 283/101; 283/110

(57) ABSTRACT

A label may include a transparent layer, and a back side viewable indicia layer on the front side of the transparent layer and being viewable through the back side of the transparent layer. The label may also include an opaque layer on the back side viewable indicia layer and blocking viewing of the back side viewable indicia layer from the front side of the transparent layer. In addition, the label may include a front side viewable indicia layer on the opaque layer to be viewable from the front side of the transparent layer. An adhesive layer may be on the back side of the transparent layer. Prior to dispensing, the label may include a carrier layer on the adhesive layer. Label stock may also be provided including a plurality of labels, and with the carrier layer supporting the plurality of labels until application.

### FIELD OF THE INVENTION

The present invention is directed to product labeling and, more particularly, to labels, label stock and associated methods for making same, such as for labeling produce.

### BACKGROUND OF THE INVENTION

Labels are widely used to convey product information to a consumer, for example. Many labels are one-sided, that is, the labeling indicia is on the outside of the label when it is affixed to the product. However, two-sided labels may be of interest for certain applications. Indeed, a number of approaches to making and using two-sided labels are disclosed in the prior art. For example, U.S. Pat. Nos. 1,054,826; 1,982,282 and 1,756,944 each discloses two-sided labels for various containers. Indeed it may often be desirable to obscure the back side indicia until after purchase by the consumer. For example, U.S. Pat. No. 6,594,927 discloses a flexible label comprising a first layer having advertising thereon and a second layer coextensive with the first layer providing a uniform thickness and including a removable premium which is separated from the label for play or collection by the user.

Labels are quite often used for produce, such as fruits and vegetables, to identify any of a number of useful things regarding the produce to the end consumer and/or to the merchant. For example, Price Look-Up (PLU) numbers may be applied to stick on labels to assist a supermarket to identify the fruits and vegetables at the check-out station. Of course, such labels may also include marketing and advertising indicia as well.

Produce labels may be applied to fruit and vegetables in packing houses, where the speed at which the labels are applied, the accuracy of the label application, and the space required by the labeler, i.e. the labeler footprint, are important. The fruit is transported in a series of lanes, each lane conveying fruit on a plurality of cradles connected to an endless belt, each cradle supporting and locating an individual fruit. The fruit in each lane is sized by conventional sizing equipment and subsequently conveyed past a plurality of labelers arranged in series or banks, each of the labelers in the series of labelers being loaded with a different label, i.e. a label imprinted with indicia to identify the size of the fruit. One advantageous type of fruit labeler is disclosed in U.S. Pat. No. 6,408,916 entitled “Labeler Having Intermittent Drive Mechanism” assigned to the assignee of the present invention and the entire contents of which are incorporated herein by reference. Such a labeler will typically use label stock in the form of wound reels or magazines of the individual labels carried on a carrier strip. The carrier strip serves as a backing or release layer that may be divided into two pieces upon passing over a V-shaped notch as the label is removed therefrom by the labeler. The label may then be carried by a rotating bellows for application to the passing fruit. In other words, a carrier strip carries thereon a series of die cut individual labels, and each label is dispensed from the labeler so that the carrier strip remains behind as the label is applied to the fruit.

The label on the fruit may include an opaque thin flexible plastic layer having opposing front and back sides. On the back side a layer of pressure sensitive adhesive is applied. The carrier strip is on the adhesive layer prior to dispensing. The front side includes an ink or indicia layer with the desired labeling information. The label may include a body portion and a small protruding tab portion, and that permits grasping by the user to thereby remove the label from the fruit for consumption.

It may be desirable in certain circumstances to provide such a produce label with its labeling indicia viewable from the front side, and with promotional or other indicia viewable from the back side. For example, Sinclair Systems International, LLC, having an office in Fresno, Calif., offers a so-called “peel and reveal” label that includes front side viewable indicia viewable from the front side, and back side viewable indicia viewable from the back side, that is, after the label has been peeled from the fruit to review the back side, such as for a marketing promotion. Such a two-sided label may be very useful for promotions where consumers can win prizes for example, as reported in Fruit Today Euromagazine, March/April 2006.

The Sinclair label is believed to be manufactured by taking conventional label stock, including a carrier layer and thin plastic film joined together by the pressure sensitive adhesive, delaminating the carrier layer from the thin plastic film, printing on the pressure sensitive adhesive layer, relaminating the plastic film to a carrier layer, and then printing the front side of the plastic layer. Unfortunately, this may require specialty printing press equipment and may produce a print that is not crisp or well defined.

### SUMMARY OF THE INVENTION

In view of the foregoing background, it is therefore an object of the present invention to provide a two-sided label and associated method suitable for labeling produce, for example.

This and other objects, features and advantages in accordance with the present invention are provided by a label including a transparent layer having a front side and a back side opposite the front side, and a back side viewable indicia layer on the front side of the transparent layer and being viewable through the back side of the transparent layer. The label may also include an opaque layer on the back side viewable indicia layer and blocking viewing of the back side viewable indicia layer from the front side of the transparent layer. In addition, the label may include a front side viewable indicia layer on the opaque layer to be viewable from the front side of the transparent layer. An adhesive layer may be on the back side of the transparent layer.

Of courser prior to dispensing, the label may include a carrier layer on the adhesive layer. Label stock may also be provided in accordance with the present invention. The label stock may include a plurality of labels, such as for produce, for example, and with the carrier layer supporting the plurality of labels until application to the produce. Such labels and label stock are more readily manufactured and provide high quality indicia viewing from both the front and back sides of the label.

The front side viewable indicia may identify produce labeled thereby with at least one of a variety of produce, a country of origin of the produce, a specific supplier of the produce, and a type of the produce. Alternatively or additionally, the front side viewable indicia layer may comprise Price Look-Up (PLU) label indicia. In addition, the back side viewable indicia layer may comprise marketing promotion label indicia.

The transparent layer may comprise a transparent flexible layer. The opaque layer may comprise a UV-cured opaque layer, to provide a sufficiently thick layer while still providing a fast drying speed. The adhesive layer may comprise a pressure sensitive adhesive layer, and the transparent layer may comprise a body portion and a gripping tab portion extending outwardly therefrom.

A method aspect is for making a label and may include providing a transparent layer having a front side and a back side opposite the front side, and having an adhesive layer on the back side of the transparent layer. The method may also include forming a back side viewable indicia layer on the front side of the transparent layer and being viewable through the back side of the transparent layer, and forming an opaque layer on the back side viewable indicia layer and blocking viewing of the back side viewable indicia layer from the front side of the transparent layer. The method may also include forming a front side viewable indicia layer on the opaque layer to be viewable from the front side of the transparent layer.

Another method aspect is directed to a method for making label stock, such as for produce. The method may include providing raw label stock comprising a transparent layer having a front side and a back side, a pressure sensitive adhesive layer on the back side of the transparent layer, and a carrier layer on the adhesive layer. The method may further include the steps of forming the back side viewable indicia layer, the opaque layer, and the front side viewable indicia.

### BRIEF DESCRIPTION OF THE DRAWINGS

FIG. 1 is a front elevation view of an orange having a two-sided label thereon in accordance with the present invention.

FIG. 2 is an enlarged rear side elevation view of the two-sided label as shown in FIG. 1.

FIG. 3 is a greatly enlarged cross-sectional view of the label as shown in FIG. 1.

FIG. 4 is a front elevation view of a reel of label stock including the labels as shown in FIG. 1.

FIG. 5 is a flowchart of a method for making the label in accordance with the present invention.

FIG. 6 is a more detailed flowchart of a method for making the label stock in accordance with the present invention.

### DETAILED DESCRIPTION OF THE PREFERRED EMBODIMENTS

The present invention will now be described more fully hereinafter with reference to the accompanying drawings in which preferred embodiments of the invention are shown. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout.

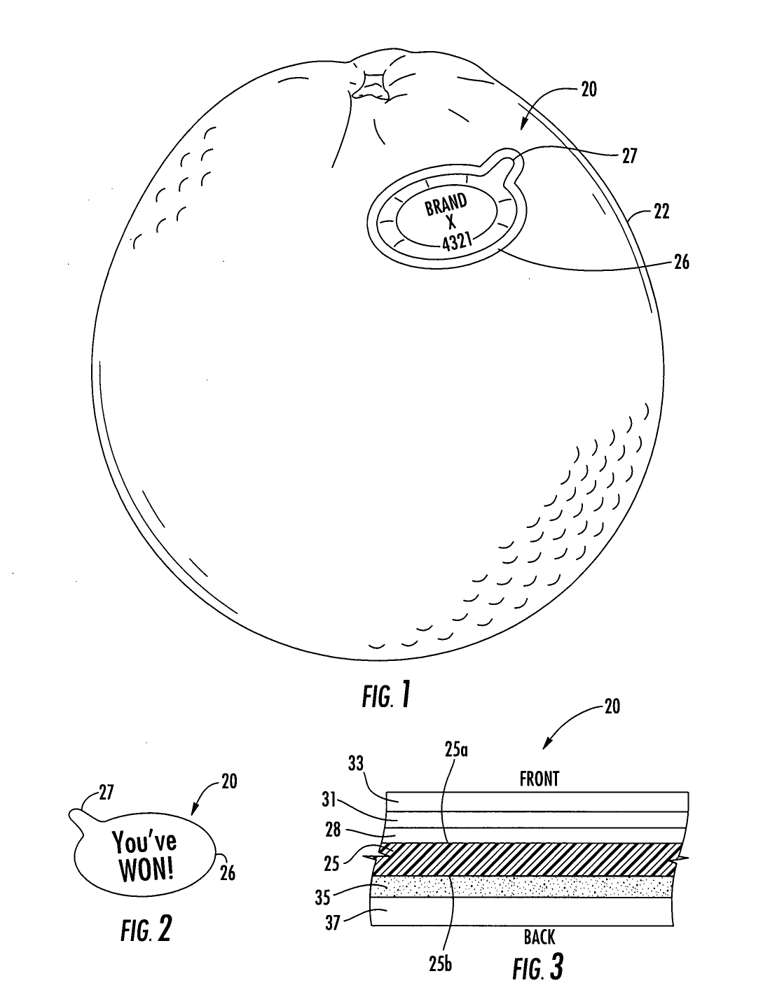

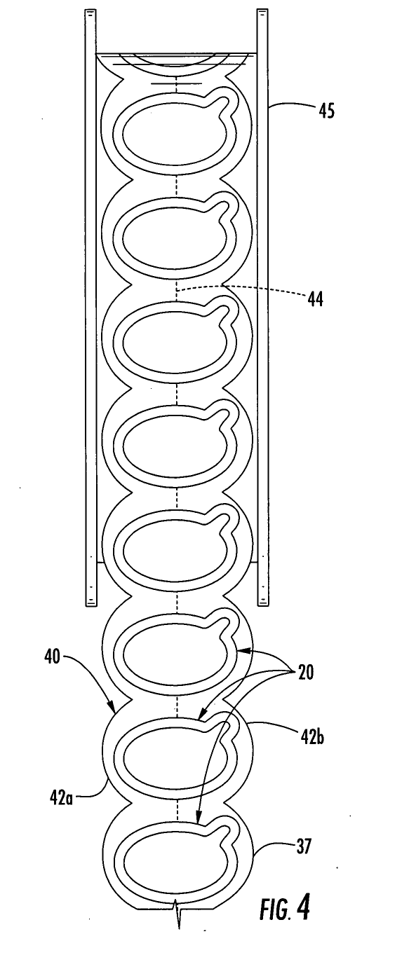

Referring initially to FIGS. 1-3, a two-sided label in accordance with the invention is now described. The label 20 is illustratively positioned on an orange 22 as shown in FIG. 1, but may be positioned on other produce or similar articles as will be appreciated by those skilled in the art. The flexibility of the label 20 may be particularly advantageous to conform to and remain adhered to an irregularly shaped article, such as the illustrated orange 22.

The label 20 includes a transparent layer 25 having a front side 25a and a back side 25b opposite the front side. The transparent layer 25 may be formed of a thin, flexible, plastic film, such as a polyethylene film, or any suitable material as will be appreciated by those skilled in the art. The thickness of the transparent layer 25 may on the order of about 1 to 1.8 mils. The transparent layer 25 illustratively includes a body portion 26 and a gripping tab portion 27 extending outwardly therefrom.

Moreover, the term transparent as used herein is not meant to necessarily convey the perfect transmittance of light therethrough, rather, all that is of interest is sufficient light transmittance so that the adjacent indicia layer described below is viewable therethrough. Accordingly, what might be considered to be a translucent and or tinted layer is also meant to be included with the term transparent.

The label 20 includes a back side viewable indicia layer 28 on the front side 25a of the transparent layer 25 and being viewable through the back side 25b of the transparent layer. The label 20 also includes an opaque layer 31 on the back side indicia layer 28 and blocking viewing of the back side viewable indicia layer from the front side 25a of the transparent layer 25.

The label 20 also illustratively includes a front side viewable indicia layer 33 on the opaque layer 31 to be viewable from the front side 25a of the transparent layer 25. An adhesive layer 35 is provided on the back side 25b of the transparent layer 25. Prior to dispensing, the label 20 may include a carrier layer 37 on the adhesive layer 35. The carrier layer 37 may be a silicone impregnated paper layer, for example, or other material as will be appreciated by those skilled in the art.

The front side viewable indicia layer 33 may identify produce labeled thereby with at least one of variety of produce, a country of origin of the produce, a specific supplier of the produce, and a type of the produce. The front side viewable indicia layer 33 may include various decorative graphics and/or text, branding information, or the like. The front side viewable indicia layer 33 may also, for example, comprise Price Look-Up (PLU) label indicia, for example. The PLU label indicia typically includes a four digit code, and sometimes an additional prefix digit, as will be appreciated by those skilled in the art. Multiple colors may be included in the front side viewable indicia layer 33 as may be printed using conventional label printing techniques.

The back side viewable indicia layer 28 may comprise marketing promotion label indicia, such as a notification of a winning label, for example. Of course, the back side viewable indicia layer 28 may be directed to other useful features as well. The back side viewable indicia layer 28 may be reversed printed using one or more colors as will also be appreciated by those skilled in the art.

The opaque layer 31 may comprise a UV-cured opaque layer, to provide a sufficiently thick layer while still providing a fast drying speed. The opaque layer may be provided by a flood coat of ink, typically all of one color, that provides complete area coverage as will also be appreciated by those skilled in the art. Of course in other embodiments, the opaque layer could be coextensive with the back side viewable indicia so as to obscure this indicia from front side viewing. Other opaque material layers are also contemplated by the present invention.

The adhesive layer 35 may comprise a pressure sensitive adhesive layer as will be appreciated by those skilled in the art. Of course, the adhesive layer 35 will be a very thin layer and will typically remain on the transparent layer 25 even after the label 20 is removed from the orange 22. Accordingly, the adhesive layer 35 is also desirably transparent. In those embodiments where none of the adhesive layer 35 remains on the transparent layer 25 after the label 20 is removed from the orange 22, the adhesive need not be transparent.

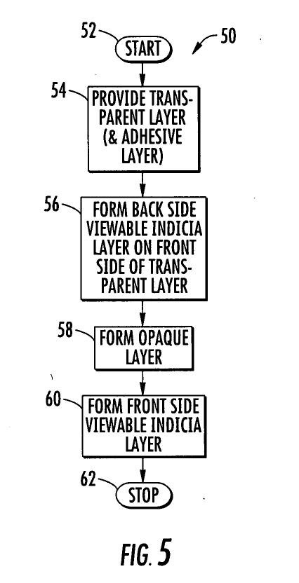

Turning now additionally to FIG. 4, label stock 40 including the labels 20 is now described. The label stock 40 illustratively includes a plurality of labels 20 for produce, for example; and with the carrier layer 37 in the form of a carrier strip 42 supporting the plurality of labels until application. The carrier strip 42 may include a central score or line of weakness 44 to facilitate separation of the carrier strip and labels 20 during application as will be appreciated by those skilled in the art. In addition, the edges 42a, 42b of the carrier strip 42 illustratively have an undulating shape to facilitate handling by the labeling equipment, although other edge configurations may also be used as will also be appreciated by those skilled in the art. The label stock 40 may be readily wound onto and thereby supported on a reel or magazine 45 that can by used in a labeler. Of course, the label stock 40 can be stored and used in other formats as well.

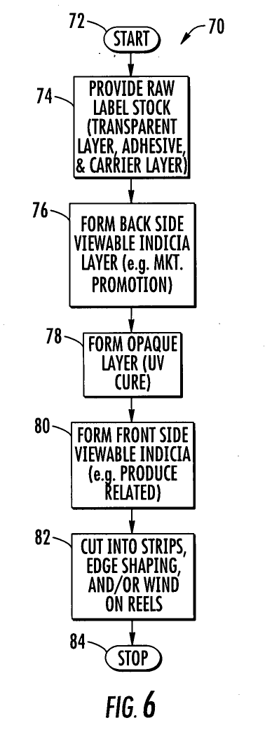

Referring now additionally to the flowchart 50 of FIG. 5, a method aspect of making the two-sided label 20 is now described. From the start (Block 52), the method includes providing a transparent layer having a front side and a back side opposite the front side, and with an adhesive layer on the back side of the transparent layer at Block 54. At Block 56 the method includes forming a back side viewable indicia layer on the front side of the transparent layer and being viewable through the back side of the transparent layer. At Block 58 the method includes forming an opaque layer on the back side indicia layer and blocking viewing of the back side viewable indicia layer from the front side of the transparent layer. The opaque layer may be a UV-curable layer, for example. The method may also include forming a front side viewable indicia layer on the opaque layer to be viewable from the front side of the transparent layer at Block 60, before stopping (Block 62). This method is considerably more straightforward than the prior Sinclair method described above that requires delamination of the carrier strip from the plastic base layer and printing on the adhesive layer, followed by relamination of the carrier layer. In addition, higher quality indicia may be produced by printing the back side viewable indicia layer on the transparent layer as in the present invention and as will be appreciated by those skilled in the art.

With further reference to the flowchart 70 of FIG. 5, another method embodiment is now described directed to making label stock, such as for produce. From the start (Block 72), the method illustratively includes providing raw label stock comprising a transparent layer having a front side and a back side, a pressure sensitive adhesive layer on the back side of the transparent layer, and a carrier layer on the adhesive layer (Block 74). The method further includes forming the back side viewable indicia layer, such as relating to marketing promotion, at Block 76. Thereafter, the opaque layer may be printed and UV cured at Block 78. The front side viewable indicia, as may relate to produce, is formed or printed at Block 80. At Block 82 the transparent layer may be die cut to leave the labels on the carrier layer, the carrier layer may be die cut into strips and providing desired edge configurations compatible with the labeling equipment, and/or the label stock wound onto reels as will be appreciated by those skilled in the art, before stopping at Block 84.

Many modifications and other embodiments of the invention will come to the mind of one skilled in the art having the benefit of the teachings presented in the foregoing descriptions and the associated drawings. Accordingly, it is understood that the invention is not to be limited to the embodiments disclosed, and that other modifications and embodiments are intended to be included within the spirit and scope of the appended claims.

1. A label comprising:
a transparent layer having a front side and a back side opposite the front side;
a back side viewable indicia layer on the front side of said transparent layer and being viewable through the back side of said transparent layer;
an opaque layer on said back side viewable indicia layer and blocking viewing of said back side viewable indicia layer from the front side of said transparent layer;
a front side viewable indicia layer on said opaque layer to be viewable from the front side of said transparent layer;
an adhesive layer on the back side of said transparent layer; and
a carrier layer on said adhesive layer.

2. (canceled)

3. The label according to claim 1 wherein said front side viewable indicia identifies produce labeled thereby with at least one of variety of produce, a country of origin of the produce, a specific supplier of the produce, and a type of the produce.

4. The label according to claim 1 wherein said front side viewable indicia layer comprises Price Look-Up (PLU) label indicia.

5. The label according to claim 1 wherein said back side viewable indicia layer comprising marketing promotion label indicia.

6. The label according to claim 1 wherein said transparent layer comprises a transparent flexible layer.

7. The label according to claim 1 wherein said opaque layer comprises a UV-cured opaque layer.

8. The label according to claim 1 wherein said adhesive layer comprises a pressure sensitive adhesive layer.

9. The label according to claim 1 wherein said transparent layer comprises a body portion and a gripping tab portion extending outwardly therefrom.

10. Label stock for produce comprising:
a plurality of labels for produce; and
a carrier layer supporting said plurality of labels until application onto the produce;
each label comprising
a transparent layer having a front side and a back side opposite the front side,
a back side viewable indicia layer on the front side of said transparent layer and being viewable through the back side of said transparent layer, said back side viewable indicia layer comprising marketing promotion label indicia,
an opaque layer on said back side viewable indicia layer and blocking viewing of said back side viewable indicia layer from the front side of said transparent layer,
a front side viewable indicia layer on said opaque layer to be viewable from the front side of said transparent layer, said front side viewable indicia identifying produce labeled thereby with at least one of variety of produce, a country of origin of the produce, a specific supplier of the produce, and a type of the produce, and
a pressure sensitive adhesive layer between the back side of said transparent layer and said carrier layer.

11. The label stock according to claim 10 wherein said front side viewable indicia layer comprises Price Look-Up (PLU) label indicia.

12. The label stock according to claim 10 wherein said transparent layer comprises a transparent flexible layer.

13. The label stock according to claim 10 wherein said opaque layer comprises a UV-cured opaque layer.

14. The label stock according to claim 10 wherein said transparent layer comprises a body portion and a gripping tab portion extending outwardly therefrom.

15. A method for making a label comprising:
providing a transparent layer having a front side and a back side opposite the front side and with an adhesive layer on the back side of the transparent layer, and with a carrier layer on the adhesive layer;
forming a back side viewable indicia layer on the front side of the transparent layer and being viewable through the back side of the transparent layer;
forming an opaque layer on the back side viewable indicia layer and blocking viewing of the back side viewable indicia layer from the front side of the transparent layer; and
forming a front side viewable indicia layer on the opaque layer to be viewable from the front side of the transparent layer.

16. (canceled)

17. The method according to claim 15 wherein the front side viewable indicia identifies produce labeled thereby with at least one of variety of produce, a country of origin of the produce, a specific supplier of the produce, and a type of the produce.

18. The method according to claim 15 wherein the front side viewable indicia layer comprises Price Look-Up (PLU) label indicia.

19. The method according to claim 15 wherein the back side viewable indicia layer comprising marketing promotion label indicia.

20. The method according to claim 15 wherein the transparent layer comprises a transparent flexible layer.

21. The method according to claim 15 wherein the opaque layer comprises a UV-curable opaque layer; and wherein forming the opaque layer comprises UV-curing the UV curable layer.

22. The method according to claim 15 wherein the adhesive layer comprises a pressure sensitive adhesive layer; and wherein the transparent layer comprises a body portion and a gripping tab portion extending outwardly therefrom.

23. A method for making label stock for produce comprising:
providing raw label stock comprising a transparent layer having a front side and a back side, a pressure sensitive adhesive layer on the back side of the transparent layer, and a carrier layer on the adhesive layer;
forming a plurality of labels from the raw label stock by
forming a back side viewable indicia layer on the front side of the transparent layer and being viewable through the back side of the transparent layer, the back side viewable indicia layer comprising marketing promotion label indicia,
forming an opaque layer on the back side viewable indicia layer and blocking viewing of the back side viewable indicia layer from the front side of the transparent layer, and
forming a front side viewable indicia layer on the opaque layer to be viewable from the front side of the transparent layer, the front side viewable indicia identifying produce labeled thereby with at least one of variety of produce, a country of origin of the produce, a specific supplier of the produce, and a type of the produce.

24. The method according to claim 23 wherein the front side viewable indicia layer comprises Price Look-Up (PLU) label indicia.

25. The method according to claim 23 wherein the transparent layer comprises a transparent flexible layer.

26. The method according to claim 23 wherein the opaque layer comprises a UV-curable opaque layer; and wherein forming the opaque layer comprises UV-curing the UV curable layer.

27. The method according to claim 23 wherein the transparent layer comprises a body portion and a gripping tab portion extending outwardly therefrom.
